(19) United States
(12) Patent Application Publication
(10) Pub. No.: US 2025/0083084 A1
(43) Pub. Date: Mar. 13, 2025

(54) AIR FILTER FOR SEVERE CHRONIC ASTHMATICS

(71) Applicant: Richard D. McClintock, SR., Woodbury, CT (US)

(72) Inventor: Richard D. McClintock, SR., Woodbury, CT (US)

(21) Appl. No.: 18/244,145

(22) Filed: Sep. 8, 2023

(51) Int. Cl. B01D 46/52; B01D 46/00

(52) U.S. Cl. CPC B01D 46/521; B01D 46/0005; B01D 46/0036

(57) ABSTRACT

An air filter for severe chronic asthmatics generates an industrial standard class 10,000 to class 100,000 clean room by utilizing the Coandă effect to replicate a laminar downflow clean room in an ordinary household room, but it conserves electricity doing so. It utilizes, unique to household air filters, pleated panels of prefilter and huge quantities of vapor purifying pleated panels containing 300-600 pounds of material. It protects the occupants by shutting down the blower motors in the event of a fire, all the while being easy to service by one person.

### PRIORITY

This application is a continuation of U.S. patent application Ser. No. 18/224,145 filed on Sep. 8, 2023.

### FIELD

The field of the present disclosure generally relates to filter devices. More particularly, the field of the invention relates to an apparatus and a method of generating a Class 10,0000 to 100,000 cleanroom within an ordinary room to remove airborne particles, molecular contaminants, volatile organic, and inorganic compounds from the air.

### BACKGROUND

There are several things that differentiate my air filter for severe chronic asthmatics from other commercially-available air filters intended to be used for treatment of chronic asthma sufferers. One cannot be allergic to allergens when there are virtually none present.

An asthma sufferer's breathing cannot be affected by organic or inorganic particles, odors, mephitic or nocuous chemicals when they are sufficiently reduced by orders of magnitude below ambient levels. At very low levels, the allergy triggers will recede to insignificance. Then the usual allergy drugs can combat the asthma sufferer's DNA-mediated, usually inherited, asthma.

For reference, HEPA is a type of pleated mechanical air filter. It is an acronym for “high-efficiency particulate air” (as officially defined by the U.S. Dept. of Energy). This type of air filter can theoretically remove at least 99.97% of dust, pollen, mold, bacteria, and any airborne particles with a size 0.3 microns (μm). The diameter specification of 0.3 microns corresponds to the worst case; the most penetrating particle size (MPPS). Particles that are larger or smaller are trapped with even higher effectiveness. Using the worst-case particle size results in the worst-case efficiency rating (i.e. 99.97% or better for all particle sizes).

### SUMMARY

An apparatus and a method are provided to convert an ordinary room into a class 10,000-100,000 clean room to remove airborne particles, molecular contaminants, mephitic or volatile organic, and inorganic compounds from the air.

In an exemplary embodiment the air filter comprises a supportive frame, sheathing, and pleated prefilters, HEPA filters, and pleated trays of absorption/destruction media. A nozzle on the output of the filter generates a powerful high velocity Coandă jet that distributes the air mostly uniformly over the entire room. Two flow rates of the filter's fan allow manual selection of the flow rates, and also an occupancy sensor can control the flow rates automatically for energy conservation.

The exemplary embodiment also features removal of the sheathing, removal of the filter elements, and partial disassembly of the frame to allow moving and positioning the air filter in the needed position.

The exemplary embodiment also features a temperature sensor which shuts down the fan when the temperature of the air exceeds normal room temperatures to help prevent the sheathing and interior components from catching fire.

### BRIEF DESCRIPTION OF THE DRAWINGS

FIGS. 1, 3 and 5 are all the same and show the left side view of the frame and air filters without the sheathing.

FIG. 2 shows the front view of the frame and air filters without the sheathing. This Embodiment is close to a class 10,000 cleanroom conversion of an ordinary room. It has the highest operating expenses. It is the best obtainable short of building a class 100 laminar down-flow cleanroom to live in.

FIG. 4 shows the front view of the frame and air filters without the sheathing. This embodiment is the least expensive version to make.

FIG. 6 shows the front view of the frame and air filters without the sheathing. This embodiment is the lowest energy cost version. However, the filtration capabilities are only close to a class 100,000 cleanroom.

FIG. 6 shows the sheathing for FIGS. 2 and 6. Sheathing for FIG. 4 would be similar.

### COMMENTARY ON THE PURPOSE OF THE INVENTION

Laminar down-flow cleanrooms are the cleanest places—other than a hard vacuum—on earth. They use grated floors to draw [pull] contaminated air into the filter system. The HEPA filters, placed across the entire ceiling, filter out 99.9-99.99% of all particles 0.3 micron or larger by simply being trapped in the small spaces of the densely packed micro-glass fibers. The smaller particles, like viruses, diffuse using Brownian motion and are trapped on the HEPA glass fibers (https://simple.wikipedia.org/wiki/Brownian_motion) (Refer to: “Investigations On The Theory Of The Brownian Movement;” edited with notes by R. Furth. Translated By A. D. Cowper. With 3 Diagrams by Einstein, Albert) onto the glass fibers and are stuck by Van der Waals' force to the surface of the fibers (https://en.wikipedia.org/wiki/Vander der Waals force). Since the air is continuously circulated, each subsequent pass filters out 99.9-99.99% of the newly introduced particles, and the previously uncontaminated filtered air is refiltered to 99.99% of 99.9%, which leaves 0.0001% of the particles remaining from the first pass. As you can see, since the air is changed twice a minute, the room gets very clean quickly. The difference between my filter and previous filters is the very high flow rate it produces at a two-times per minute air change in a typically sized household room. This results in a Class 100,000 cleanroom per FED_STD-209E specifications. Also, ISO 14644-1 standards. No other household air filter can ever produce this level of cleanliness in a normally inhabited room.

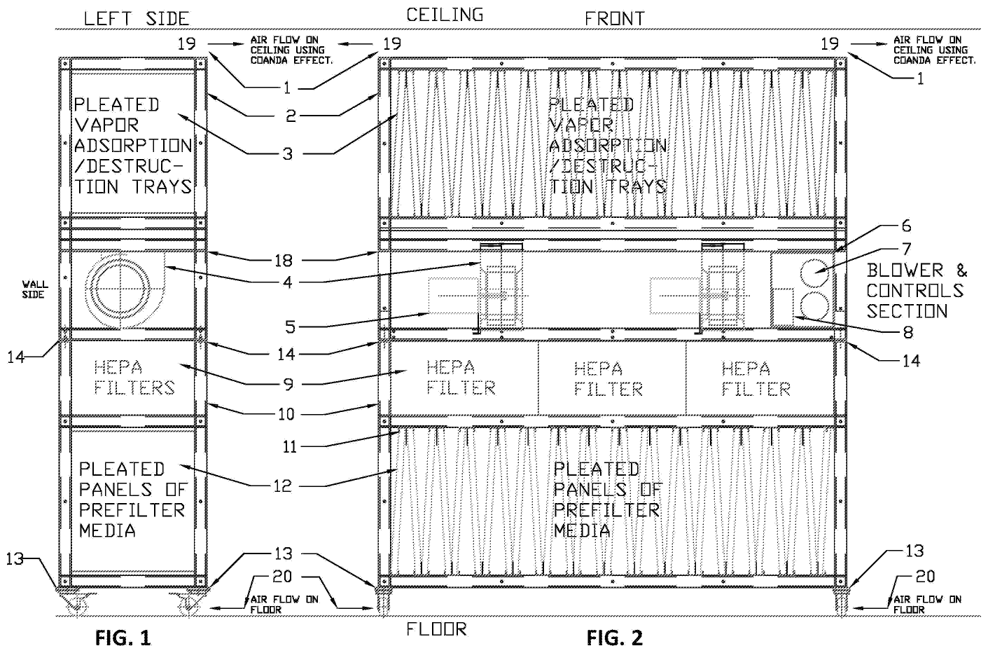

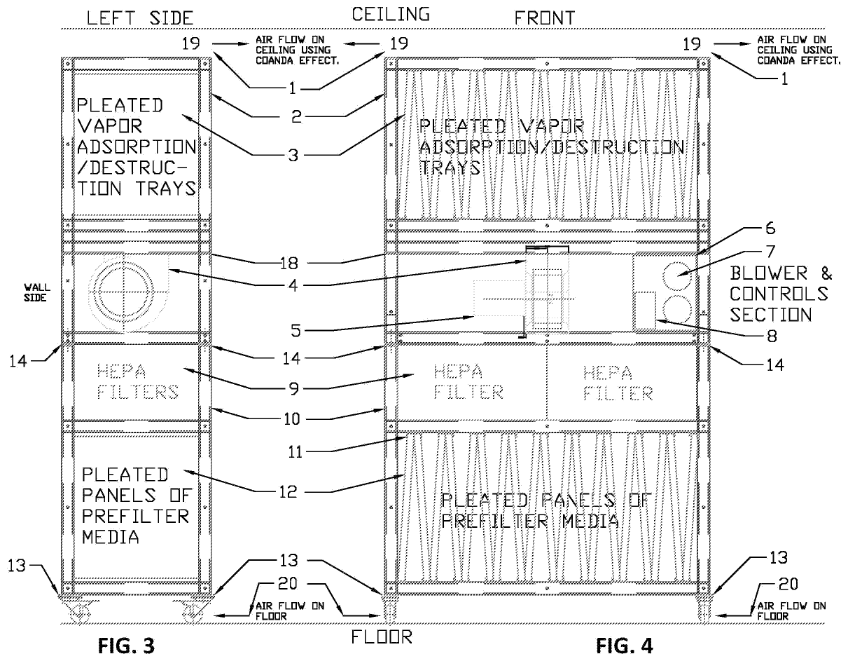

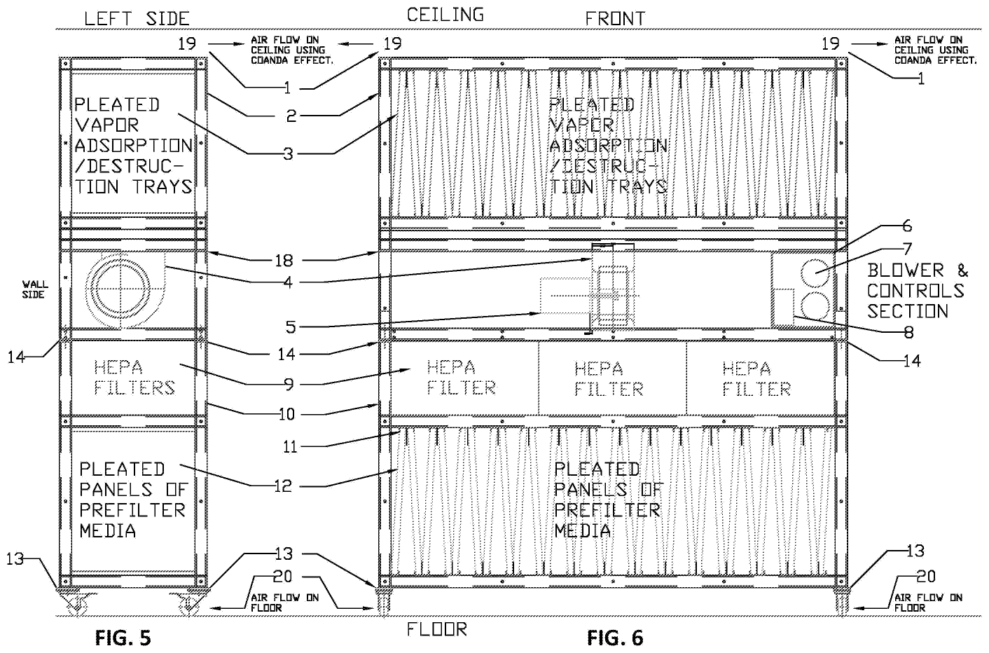

The difference between my air filter and others is that it utilizes the Coandă effect to produce an effective (laminar] down-flow cleanroom in an ordinary household room. (Coanda, H. U.S. Pat. No. 2,052,869; “Device for Deflecting a Stream of Elastic Fluid Projected into an Elastic Fluid (1936)”; Coanda H. (1936a), U.S. Pat. No. 3,261,162, (Lifting Device Coanda Effect) (https://en.wikipedia.org/wiki/Coandăeffect) (A perfect visual of the Coandă effect: https://www.youtube.com/watch?v=NvzXKZNJ7ZU) (A good description: http://www.thermofluids.co.uk/effect.php). The narrow slot of the filter discharge between the top edge of the filter and the ceiling of the room produces the high velocity Coandă jet that distributes the air over the entire room, #1 of FIGS. 1, 2, 3, 4, 5 ands 6. Note two things that happen: the air at the bottom of the jet encounters friction with the room air and slows down so that the air tends to follow the fan-induced flow of air downward to the floor to return to the filter, sweeping all contaminants back into the filter. Further, the air in the main Coandă effect air-jet encounters an increasing area as it spreads across the room, thus slowing down. This slowing down of the air-jet is also aided by air friction against the ceiling. The slower air tends to be influenced by the blower fans of the air filter over the Coandă effect, so that it drops downward and sweeps the room-generated contaminants into the filter. The only two references that I can find to the Coandă effect used with air filters is Air Quality Engineering, 7140 Northland Drive North, Brooklyn Park, MN 55428-1520. Please see their excellent description and drawing at “https://www.air-quality-eng.com/buyer-resources/coanda/”. In their description of their use of the Coandă effect, they make it clear that the flow rate of the filter does not produce a thorough mixing of the air in the room, so that there exists in the room a temperature gradient that promotes convection currents. They make it clear that their purpose is to remove the haze of cigarette smoke in places like bars. They contrast their electrostatic air filter to their competition's horizontal air movement. In my design, the flow rate and thorough mixing of temperatures of air and the high velocity of air in the room eliminates any hint of convection currents. Further, my design not only eliminates cigarette smoke, it brings an ordinary household room very close to a Class 10,000 Cleanroom. The air is almost fully sterile. The other reference is from Jul. 29, 2010 #US 2010/0186357 A1 entitled “Air Filter” by inventors Yasukata Takeda and Masaki Ohtsuka. The patent is about minimizing bypass air from the filter going around the back of the filter. The drawings of the air flow away from a wall in the rest of the room show fully turbulent air. My invention is totally different.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first portion” may be made. However the specific reference should not be interpreted as a literal sequential order but rather that the “first portion” is different from a “second portion.” Thus, the specific details set forth are merely exemplary.

The specific details may be varied from and still be contemplated to be within the spirit and scope of the present disclosure. The term “coupled” is defined as meaning connected either directly to the component or indirectly to the component through another component. Further as used herein, the terms “about”, “approximately”, or “substantially” for any numerical values or ranges indicate a suitable dimensional tolerance that allows the part or collection of components to function for its intended purpose as described herein.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

The use of a single or two smaller fans to drive the air through the filters creates more space to house filters, permitting the filters to be much larger in size than would be otherwise possible, #4 of FIGS. 2, 4, and 6. Use of smaller fans also reduces fan noise.

The larger filter elements are closely pleated to put the maximum possible surface area to work at low filter face velocity, allowing low back pressure against the fans and higher efficiency of filtering (#3 & #12 of FIGS. 2, 4, and 6). This remarkedly reduces electricity costs and amperage so that special heavy-duty wiring does not need to be installed to power the filter.

The air filter is modular in construction, allowing its large size and weight to be broken down into reasonable sizes and weights to allow moving them into the house and also upstairs and around corners to get them into the rooms needing filtering. See #2 & #10 and splitting at #14, FIGS. 1, 2, 3, 4, 5, and 6.

The foot pads, on which the casters are mounted, are deliberately offset from the steel frame to provide shelves to hold the hardwood plywood sheathing of the air filter frame in place using just one hand. See #13 of FIGS. 1, 2, 3, 4, 5, and 6. The typical upper and lower sheathing is shown in FIG. 7 as numbers 16 & 17. This enables one person to unscrew the screws while holding the sheathing to The frame with his other hand. Thus, it is possible for only one person to fully service the filter and Change the filter media because, if the other person may be disabled by their asthma, they may not be able to help.

In the control box (#6 of FIGS. 2, 4, and 6), analog differential-pressure gauges, (#7 of FIGS. 2, 4, and 6), with prominent “Change This Filter” indicator lights, give an indication of when Individual filter banks need changing and indicate must-change points. A NEMA Standard industrial motor starter protects the fan motors from burn-out. Large full-house main breaker box-type surge suppressors protect the highly energy-efficient electronic ECM fan motors (#5 of FIGS. 2, 4, and 6) from the damaging effect of surges. The HEPA filters are UL-rated along with all components of the JIC Standard control panel and mostly NEMA controls themselves. Long life is thus assured.

Use of a thermostat that shuts down the air filter when temperatures vastly exceed possible household room temperatures, as when a fire has started, helps prevent the 300-500 pounds of activated charcoal and the 4-layer heavily pleated pre-filter #3 & #12 of FIGS. 2, 4, and 6, from catching fire.

Using of pleated panels of pre-filters (#12 of FIGS. 2, 4, and 6) reduces fan back pressure, and minimizes energy use of the fan motors, (#5 of FIGS. 2, 4, and 6). It also increases contaminant holding and prolongs life between pre-filter changes. This is a novel use in the general use of pre-filters.

Use of pleated trays, #3 of FIGS. 2, 4, and 6, containing, for example, activated carbon granules, activated alumina, sodium permanganate, and/or potassium permanganate pellets or mixtures of them for absorbing or reacting and rendering harmless gaseous contaminants reacting with or absorbing vapors and reactive or poisonous gasses to reduce fan back pressure, #4 of FIGS. 2, 4, and 6, and, thus, energy use of the fan motors, #5 of FIGS. 2, 4, and 6. It also allows a massive increase in the quantity of material in the trays. This is common in industrial applications, but is unknown and a novel use in household filters.

If the ceiling is too high to result in a restricted area generating a powerful Coandă effect jet, then an extension to the housing will be used to get the vent closer to the ceiling. This will create a room very close to a Class 10,000 cleanroom.

Regular HVAC air turning vanes can also be employed in the high ceiling extension to produce the necessary jet for the Coandă effect for best air cleaning.

If the ceiling is not too high, the top side panels (#16 of FIG. 7), can be custom made to be higher, eliminating the need for a separate frame.

Use of an occupancy sensor, #8 of FIGS. 2, 4, and 6, to increase air flow to maximum filtering for the occupants of the room. A low-power maintenance mode provides enough airflow and filtering to stop contaminants from settling out and contaminating surfaces of the room when the room is unoccupied.

Use of a bank of HEPA 99.9% or greater at arresting PM 2.5 particles to reduce back pressure and reduce operating costs, #9 of FIGS. 2, 4, and 6.

### The Air Filter for Severe Chronic Asthmatics Can be Built as Follows

Use lengths of 2×2×0.25-wall square tubing to form the frame. Upper frame #2, lower frame #10 of FIGS. 1, 2, 3, 4, 5, and 6.

All tubes will be chamfered to make deep penetrating welds during construction.

Channels formed of 16 gage steel provide support for the filter pads and adsorption trays, #11 of FIGS. 2, 4, and 6. These are optimally spaced to provide the maximum flow rate and maximum surface area of filter exposure.

The pads used for attaching the casters are welded on offset from the frame to form shelves, #13 of FIGS. 2, 4, and 6. On these shelves the plywood sheathing is rested during attachment to the frame, #17 of FIG. 7, This allows a single person to position the panels and hold them in place while screwing in the pan head screws to hold the panels in place. The upper level of panels, #16 of FIG. 7, is supported by the edge of the lower panels in similar manner to allow fixing of the attaching screws.

Tight tolerances are used to cage the air filters and to minimize bypass air flow. A small clearance allows an insignificant bypass air flow but allows easy change out of filters. The constant recirculation of room air removes the tiny number of bypassed particles.

The prefilters #12 of FIGS. 2, 4, and 6 are depth filters to maximize contaminant holding while minimizing pressure drop for best efficiency. These should be 40% efficient at 0.5 microns, 80% efficient at 1.8 microns, and 98% at 6 microns. The efficiency at the dangerous PM 2.5 is minimal. That is what the HEPA filters are for, #9 of FIGS. 2, 4, and 6.

All welds on the frame are ground flat to allow the upper and lower ¾″ plywood panels to seat firmly without bypass air flow, #16 & 17 of FIG. 7.

The filter housing is split about mid-height to allow reduction in weight so that only two men are necessary to bring in the frame halves and to allow sufficient clearance to enter doorways, go upstairs, and allow turning in hallways to get the filter into position, #14 of FIGS. 1, 2, 3, 4, 5, and 6. Final assembly is in the room to house the filter.

An industrial control panel houses the alarmed filter back pressure gauges to indicate time to change the filters, #6 & 7 of FIGS. 2, 4, and 6. Whole house surge suppressors provide robust protection for the high-efficiency ECM motors, #5 of FIGS. 2, 4, and 6. An industrial motor starter and control circuity provides flow control along with the occupancy sensor to maximize life and reduce running cost, #8 of FIGS. 2, 4, and 6. Plugin relays, with a spare relay installed, provide robust reliability.

A shelf of 16-gage sheet steel, #18 of FIGS. 1, 2, 3, 4, 5, and 6, holds the fans and separates the suction bottom-half of the air filter frame, #10 of FIGS. 2, 4, and 6, from the pressurized upper half, #2 of FIGS. 1, 2, 3, 4, 5, and 6.

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first portion” may be made. However the specific reference should not be interpreted as a literal sequential order but rather that the “first portion” is different from a “second portion.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further as used herein, the terms “about”, “approximately”, or “substantially” for any numerical values or ranges indicate a suitable dimensional tolerance that allows the part or collection of components to function for its intended purpose as described herein.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

The use of a single or two smaller fans to drive the air through the filters creates more space to house filters, permitting the filters to be much larger in size than would be otherwise possible, #4 of FIGS. 2, 4, and 6. Use of smaller fans also reduces fan noise.

The larger filter elements are closely pleated to put the maximum possible surface area to work at low filter face velocity, allowing low back pressure against the fans and higher efficiency of filtering (#3 & #12 of FIGS. 2, 4, and 6). This remarkedly reduces electricity costs and amperage so that special heavy-duty wiring does not need to be installed to power the filter.

The air filter is modular in construction, allowing its large size and weight to be broken down into reasonable sizes and weights to allow moving them into the house and also upstairs and around corners to get them into the rooms that needs filtering. See #2 & #10 and splitting at #14, FIGS. 1, 2, 3, 4, 5, and 6.

The foot pads, on which the casters are mounted, are deliberately offset from the steel frame to provide shelves to hold the hardwood plywood sheathing of the air filter frame in place using just one hand. See #13 of FIGS. 1, 2, 3, 4, 5, and 6. The typical upper and lower sheathing is shown in FIG. 7 as numbers 16 & 17. This enables one person to unscrew the screws while holding the sheathing to The frame with his other hand. Thus, it is possible for only one person to fully service the filter and Change the filter media because, if the other person may be disabled by their asthma, they may not be able to help.

In the control box (#6 of FIGS. 2, 4, and 6), analog differential-pressure gauges, (#7 of FIGS. 2, 4, and 6), with prominent “Change This Filter” indicator lights, give an indication of when Individual filter banks need changing and indicate must-change points. A NEMA Standard industrial motor starter protects the fan motors from burn-out. Large full-house main breaker box-type surge suppressors protect the highly energy-efficient electronic ECM fan motors (#5 of FIGS. 2, 4, and 6) from the damaging effect of surges. The HEPA filters are UL-rated along with all components of the JIC Standard control panel and mostly NEMA controls themselves. Long life is thus assured.

Use of a thermostat that shuts down the air filter when temperatures vastly exceed possible household room temperatures, as when a fire has started, helps prevent the 300-500 pounds of activated charcoal, #3 of FIGS. 2, 4, and 6, and the 4-layer heavily pleated pre-filter, #12 of FIGS. 2, 4, and 6, from catching fire.

Using of pleated panels of pre-filters (#12 of FIGS. 2, 4, and 6) reduces fan back pressure, and minimizes energy use of the fan motors, (#5 of FIGS. 2, 4, and 6). It also increases contaminant holding and prolongs life between pre-filter changes. This is a novel use in the general use of pre-filters.

Use of pleated trays, #3 of FIGS. 2, 4, and 6, containing, for example, activated carbon granules, activated alumina, sodium permanganate, and/or potassium permanganate pellets or mixtures of them for absorbing or reacting and rendering harmless gaseous contaminants reacting with or absorbing vapors and reactive or poisonous gasses to reduce fan back pressure, #4 of FIGS. 2, 4, and 6, and, thus, energy use of the fan motors, #5 of FIGS. 2, 4, and 6. It also allows a massive increase in the quantity of material in the trays. This is common in industrial applications, but is unknown and a novel use in household filters.

If the ceiling is too high to result in a restricted area generating a powerful Coandă effect jet, then an extension to the housing will be used to get the vent closer to the ceiling. This will create a room very close to a Class 10,000 cleanroom.

Regular HVAC air turning vanes can also be employed in the high ceiling extension to produce the necessary jet for the Coandă effect for best air cleaning.

If the ceiling is not too high, the top side panels (#16 of FIG. 7), can be custom made to be higher, eliminating the need for a separate frame.

Use of an occupancy sensor, #8 of FIGS. 2, 4, and 6, to increase air flow to maximum filtering for the occupants of the room. A low-power maintenance mode provides enough airflow and filtering to stop contaminants from settling out and contaminating surfaces of the room when the room is unoccupied.

Use of a bank of HEPA 99.9% or greater at arresting PM 2.5 particles to reduce back pressure and reduce operating costs, #9 of FIGS. 2, 4, and 6.

The Air Filter for Severe Chronic Asthmatics can be built as follows:
Use lengths of 2×2×0.25-wall square tubing to form the frame. Upper frame #2, lower frame #10 of FIGS. 1, 2, 3, 4, 5, and 6.

All tubes will be chamfered to make deep penetrating welds during construction.

Channels formed of 16 gage steel provide support for the filter pads and adsorption trays, #11 of FIGS. 2, 4, and 6. These are optimally spaced to provide the maximum flow rate and maximum surface area of filter exposure.

The pads used for attaching the casters are welded on offset from the frame to form shelves, #13 of FIGS. 2, 4, and 6. On these shelves the plywood sheathing is rested during attachment to the frame, #17 of FIG. 7, This allows a single person to position the panels and hold them in place while screwing in the pan head screws to hold the panels in place. The upper level of panels, #16 of FIG. 7, is supported by the edge of the lower panels in similar manner to allow fixing of the attaching screws.

Tight tolerances are used to cage the air filters and to minimize bypass air flow. A small clearance allows an insignificant bypass air flow but allows easy change out of filters. The constant recirculation of room air removes the tiny number of bypassed particles.

The prefilters #12 of FIGS. 2, 4, and 6 are depth filters to maximize contaminant holding while minimizing pressure drop for best efficiency. These should be 40% efficient at 0.5 microns, 80% efficient at 1.8 microns, and 98% at 6 microns. The efficiency at the dangerous PM 2.5 is minimal. That is what the HEPA filters are for, #9 of FIGS. 2, 4, and 6.

All welds on the frame are ground flat to allow the upper and lower ¾″ plywood panels to seat firmly without bypass air flow, #16 & 17 of FIG. 7.

The filter housing is split about mid-height to allow reduction in weight so that only two men are necessary to bring in the frame halves and to allow sufficient clearance to enter doorways, go upstairs, and allow turning in hallways to get the filter into position, #14 of FIGS. 1, 2, 3, 4, 5, and 6. Final assembly is in the room to house the filter.

An industrial control panel houses the alarmed filter back-pressure gauges to indicate time to change the filters, #6 & 7 of FIGS. 2, 4, and 6. Whole house surge suppressors provide robust protection for the high-efficiency ECM motors, #5 of FIGS. 2, 4, and 6. An industrial motor starter and control circuity provides flow control along with the occupancy sensor to maximize life and reduce running cost, #8 of FIGS. 2, 4, and 6. Plugin relays, with a spare relay installed, provide robust reliability.

A shelf of 16-gage sheet steel, #18 of FIGS. 1, 2, 3, 4, 5, and 6, holds the fans and separates the suction bottom-half of the air filter frame, #10 of FIGS. 2, 4, and 6, from the pressurized upper half, #2 of FIGS. 1, 2, 3, 4, 5, and 6.
